(19) United States
(12) Patent Application Publication
(10) Pub. No.: US 2023/0055523 A1
(43) Pub. Date: Feb. 23, 2023

(54) METHOD, APPARATUS, AND STORAGE MEDIUM FOR GENERATING TEST CASES

(71) Applicant: XEPIC CORPORATION LIMITED, Nanjing (CN)

(72) Inventors: Shichao GAO, Shenzhen (CN); Huiping WU, Shenzhen (CN)

(21) Appl. No.: 17/876,312

(22) Filed: Jul. 28, 2022

(30) Foreign Application Priority Data
Aug. 18, 2021 (CN) 202110946898.1

(51) Int. Cl. G06F 11/36

(52) U.S. Cl. CPC G06F 11/3676; G06F 11/3684

(57) ABSTRACT

Embodiments of the present disclosure provide a method, an apparatus, and a storage medium for generating a plurality of test cases by a Portable Stimulus Standard (PSS) tool in a PSS environment. The test cases are used to test a logic system design. The method comprises: acquiring a configuration file and a coverage target of the logic system design; generating a scenario model according to the configuration file; generating the plurality of test cases according to the scenario model; determining whether the plurality of test cases satisfy the coverage target; in response to the plurality of test cases failing to satisfy the coverage target, determining a difference between the plurality of test cases and the coverage target; and updating the scenario model according to the difference.

### CROSS-REFERENCE TO RELATED APPLICATION

This application claims the benefits of priority to Chinese Application No. 202110946898.1, filed Aug. 18, 2021, the entire content of which is incorporated herein by reference.

### TECHNICAL FIELD

The present disclosure relates to the technical field of logical system design and, more particularly, to a method, an apparatus, and storage medium for generating test cases.

### BACKGROUND

In the field of integrated circuit (IC) verification, simulation generally refers to compiling a design and running the compiled design on a computer or a hardware emulation apparatus, so as to simulate and test the various functions of the design. The design can be, for example, a design of an Application Specific Integrated Circuit (ASIC) or a system-on-chip (SOC). Therefore, the design that is tested or verified in the simulation can also be referred to as a Device Under Test (DUT).

While test cases required by a simulation are being generated, it takes a long time to satisfy a coverage target of the simulation test by randomly generating test cases. In addition, when the users define the coverage target, it is difficult for the randomly generated test cases to satisfy the user-defined coverage target accurately.

The DUT can be simulated in different test environments. Each simulation needs to generate test cases repeatedly for the test environment, and whether the test cases satisfy the coverage target can be verified only after running the simulation.

### SUMMARY

In accordance with the disclosure, there is provided a method, an apparatus and storage medium for generating test cases.

A first aspect of the present disclosure provides a method for generating a plurality of test cases in a Portable Stimulus Standard (PSS) environment, wherein the test cases are used to test a logical system design. The method comprising: acquiring a configuration file and a coverage target of the logical system design; generating a scenario model according to the configuration file; generating a plurality of test cases according to the scenario model; determining whether the plurality of test cases satisfy the coverage target; in response to the plurality of test cases failing to satisfy the coverage target, determining a difference between the plurality of test cases and the coverage target; and updating the scenario model according to the difference.

A second aspect of the present disclosure provides an apparatus, comprising: a memory for storing a set of instructions; and at least one processor configured to execute the set of instructions to perform the method described in the first aspect.

A third aspect of the present disclosure provides a non-transitory computer-readable storage medium that stores a set of instructions of an apparatus. The set of instructions is used to cause the apparatus to perform the method described in the first aspect.

### BRIEF DESCRIPTION OF THE DRAWINGS

To describe the technical solutions in the present disclosure more clearly, the following will briefly introduce the figures that will be used in the embodiments. Obviously, the figures in the following description are merely exemplary, for those ordinary skilled in the art, without inventive work, other figures can be obtained based on these figures.

FIG. 1 illustrates a schematic diagram of a host according to embodiments of the present disclosure.

FIG. 2 illustrates a schematic diagram of a test environment.

FIG. 3A illustrates a schematic diagram of a simulation test system according to embodiments of the present disclosure.

FIG. 3B illustrates a schematic diagram of a PSS tool according to embodiments of the present disclosure.

FIG. 3C illustrates a schematic diagram of exemplary code for a coverage test file according to embodiments of the present disclosure.

FIG. 3D illustrates a schematic diagram of exemplary code for a scenario model according to embodiments of the present disclosure.

FIG. 3E illustrates a schematic diagram of exemplary code for a test case according to embodiments of the present disclosure.

FIG. 4 is a flowchart of a method for generating test cases according to embodiments of the present disclosure.

### DETAILED DESCRIPTION

Exemplary embodiments will be described in detail herein, and examples thereof are shown in the accompanying drawings. In the following description involving the accompanying drawings, the same numerals in different accompanying drawings indicate the same or similar elements, unless specified otherwise. Implementations described in the following exemplary embodiments do not represent all implementations consistent with the disclosure. In contrast, they are merely examples of devices and methods consistent with some aspects of the disclosure as described in detail in the appended claims.

Terms in the disclosure are merely used for describing specific embodiments, rather than limiting the disclosure. Singular forms “a (an)”, “said”, and “the” used in the present disclosure and the appended claims also include plural forms, unless clearly specified in the context that other meanings are denoted. It should be further understood that the term “and/or” used herein refers to and includes any or all possible combinations of one or more associated items listed.

It should be understood that, although terms such as “first”, “second”, and “third” can be used to describe various kinds of information in the disclosure, these kinds of information should not be limited by the terms. These terms are merely used to distinguish information of the same type from each other. For example, without departing from the scope of the disclosure, the first information can also be referred to as second information, and similarly, the second information can also be referred to as first information. Depending on the context, the word “if” used herein can be explained as “when . . . ”, “as . . . ”, or “in response to the determination”.

A simulation test is to check whether the logical system design can achieve the predetermined function by applying various incentives to the logical system design on the host running the simulation test system.

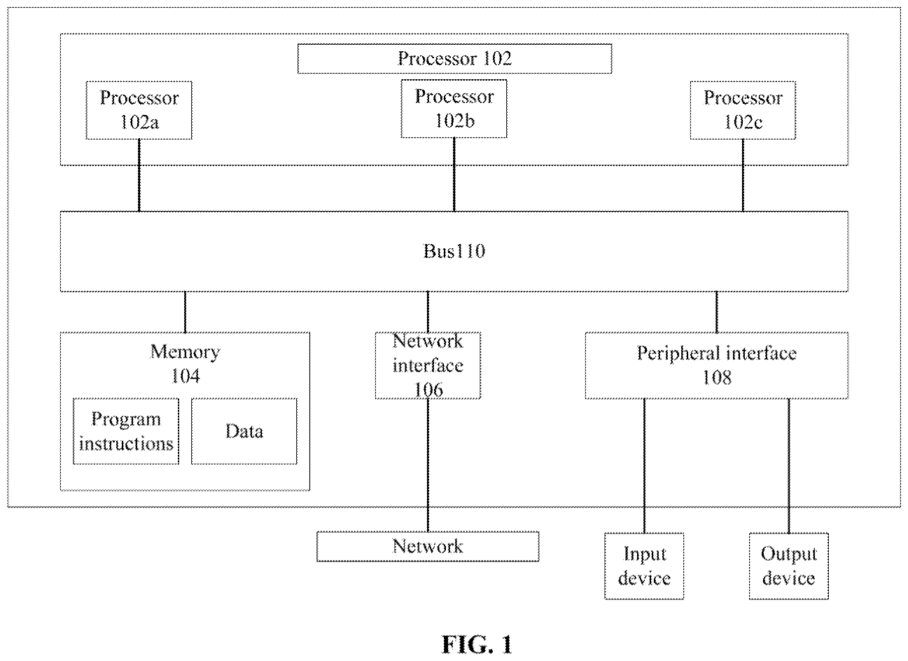

FIG. 1 illustrates a schematic diagram of a host 100 according to embodiments of the present disclosure. The host 100 can be an apparatus for running the simulation test system. As shown in FIG. 1, the host 100 can include: a processor 102, a memory 104, a network interface 106, a peripheral interface 108, and a bus 110. The processor 102, the memory 104, the network interface 106, and the peripheral interface 108 can communicate with each other through the bus 110 in the host.

The processor 102 can be a central processing unit (CPU), an image processor, a neural network processor (NPU), a microcontroller (MCU), a programmable logical device, a digital signal processor (DSP), an application specific integrated circuit (ASIC), or one or more integrated circuits. The processor 102 can perform functions related to the techniques described in the disclosure. In some embodiments, the processor 102 can also include a plurality of processors integrated into a single logical component. As shown in FIG. 1, the processor 102 can include a plurality of processors 102a, 102b, and 102c.

The memory 104 can be configured to store data (e.g., an instruction set, computer codes, intermediate data, etc.). In some embodiments, the simulation test system used to simulate the test design can be a computer program stored in the memory 104. As shown in FIG. 1, the stored data can include program instructions (e.g., program instructions used to implement the simulation method of the present disclosure) and the data to be processed (e.g., the memory 104 can store temporary codes generated during compiling). The processor 102 can also access stored program instructions and data, and execute the program instructions to operate the data to be processed. The memory 104 can include a non-transitory computer-readable storage medium, such as a volatile storage device or a non-volatile storage device. In some embodiments, the memory 104 can include a random-access memory (RAM), a read-only memory (ROM), an optical disk, a magnetic disk, a hard disk, a solid-state disk (SSD), a flash memory, a memory stick, and the like.

The network interface 106 can be configured to enable the host 100 to communicate with other external devices via a network. The network can be any wired or wireless network capable of transmitting and receiving data. For example, the network can be a wired network, a local wireless network (e.g., a Bluetooth network, a Wi-Fi network, a near field communication (NFC), etc.), a cellular network, the Internet, or a combination of the above. It is appreciated that the type of network is not limited to the above specific examples. In some embodiments, the network interface 106 can include any number of network interface controllers (NICs), radio frequency modules, receivers, modems, routers, gateways, adapters, cellular network chips, or random combinations of two or more of the above.

The peripheral interface 108 can be configured to connect the host 100 to one or more peripheral devices to implement input and output information. For example, the peripheral devices can include input devices, such as keyboards, mice, touch pads, touch screens, microphones, various sensors, and output devices, such as displays, speakers, vibrators, and indicator lights.

The bus 110, such as an internal bus (e.g., a processor-storage bus), an external bus (e.g., a USB port, a PCI-E bus), and the like, can be configured to transmit information among various components of host 100 (e.g., the processor 102, the memory 104, the network interface 106, and the peripheral interface 108).

It should be noted that, although the above-described host architecture merely illustrates the processor 102, the memory 104, the network interface 106, the peripheral interface 108, and the bus 110, the host architecture can also include other components needed for normal operations. In addition, it is appreciated for those ordinary skilled in the art that the foregoing devices can also include the components needed to implement the solutions of embodiments of the present disclosure and do not require to include all the components of figures.

In the field of logical system design (e.g., a chip design), a simulation test system can be used to simulate the design. The simulation test system can be a computer program running on the host 100 as shown in FIG. 1.

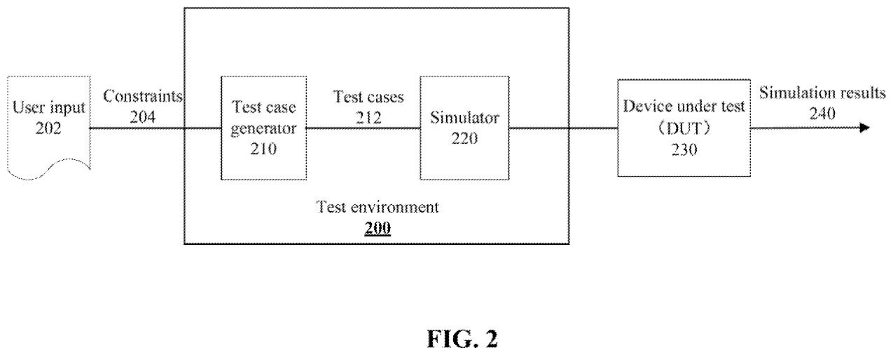

FIG. 2 illustrates a schematic diagram of a test environment 200.

Generally, the test environment 200 can include a verification environment written in SystemVerilog language, such as a Universal Verification Methodology (UVM) environment. For example, the test environment 200 can be a testbench. The test environment 200 can include a test case generator 210 and a simulator 220. The test case generator 210 can accept constraints 204 from user input 202 for generating test cases 212. Generally, the source language for writing constraints 204 is a high-level programming language. The high-level programming language can be a software programming language such as C and C++, a domain description language such as Domain Specific Language (DSL), a hardware description language such as SystemVerilog, and the like which is input by the user. Generally, the test case generator 210 can be stored in the memory 104 as shown in FIG. 1 and executed by the processor 102 to generate the test cases 212 according to the constraints 204. The simulator 220 can simulate and test the DUT 230. It is appreciated that the test cases 212 can also be used for an emulator.

While running the simulation, the test case generator 210 can generate specific test cases 212 based on the constraints 204 dynamically and in real-time. The simulator 220 collects simulation results 240 during the process of running test cases 212 for simulation. The simulation results 240 can be, for example, a log file, which can be printed after the simulation. The simulation results 240 can include test coverage. The user can also calculate the test coverage of the simulation based on the simulation results 204. In other words, generally only during the process of the simulation, the test case generator 210 in the test environment 220 can generate specific test cases, and then determine whether the test cases satisfy the coverage target according to the dynamic simulation results. If the current test cases fail to satisfy the coverage target, the user needs to adjust the constraints and re-test the newly generated test cases. In other words, before the dynamic simulation is performed, the user cannot know whether the test cases under the current constraints satisfy the coverage target. And to achieve the coverage target, the dynamic simulation needs to be repeated many times, which is time-consuming. To solve the above problems, embodiments of the present disclosure provide a method, an apparatus and storage medium for generating a plurality of test cases in a Portable Stimulus Standard (PSS) environment.

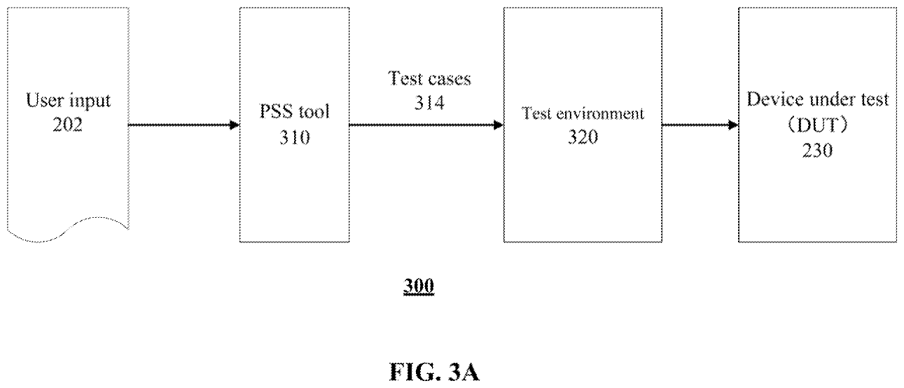

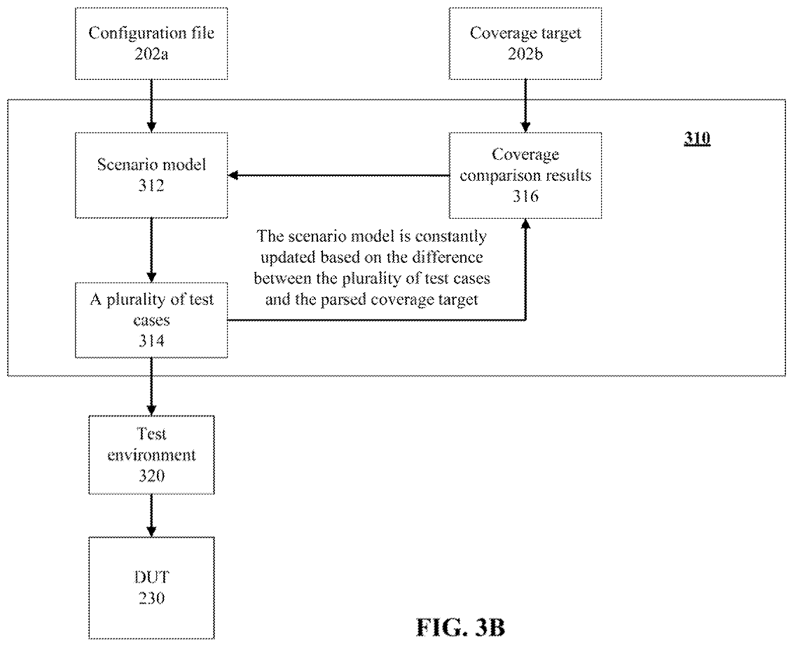

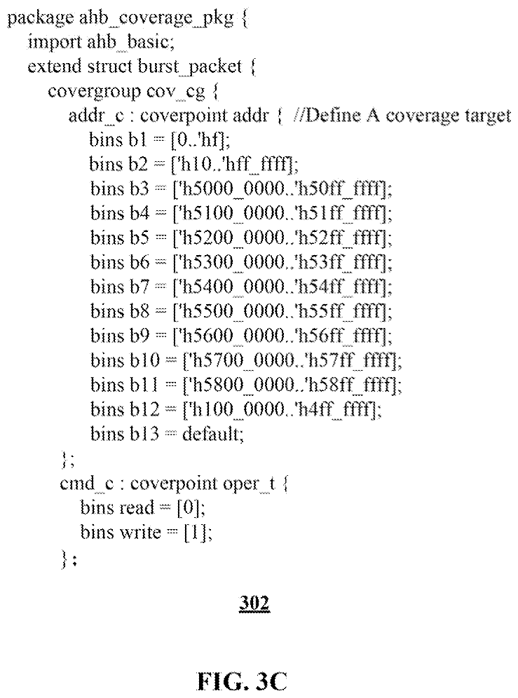

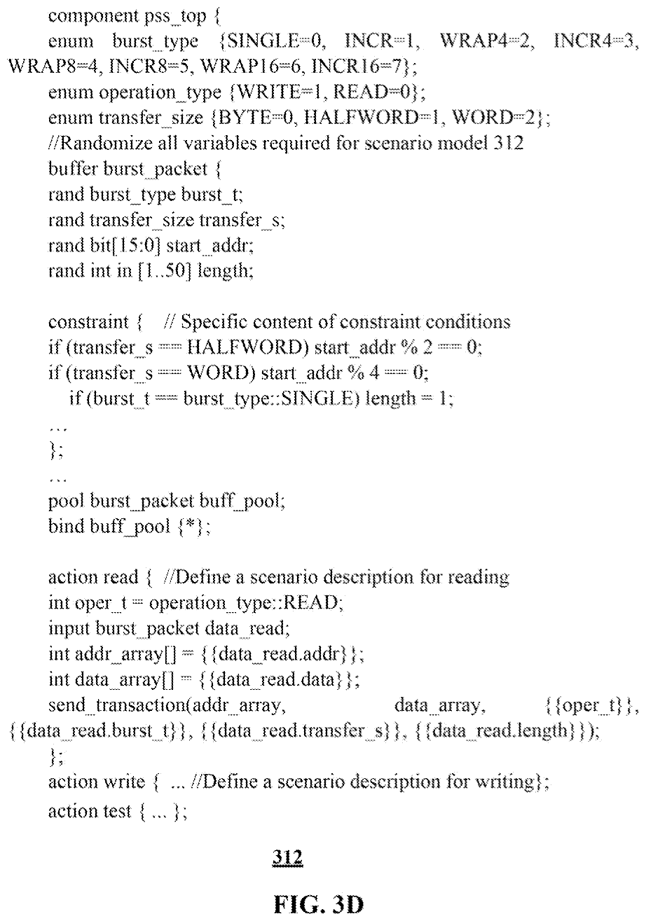

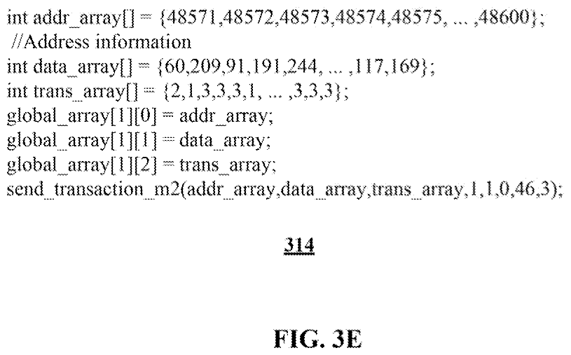

FIG. 3A illustrates a schematic diagram of a simulation test system 300 according to embodiments of the present disclosure. As shown in FIG. 3A, the simulation test system 300 can include a Portable Stimulus Standard (PSS) tool 310, a test environment 320 and a DUT 230. The simulation test system 300 can generate a plurality of test cases according to the user input 202, for testing a plurality of functional units of the logical system design during the simulation process of the logical system design.

The PSS tool 310 can generate a plurality of test cases across platforms based on the user input 202. In the simulation test scenario, the efficiency of the test needs to be taken into account. For example, the same test cases can be tested on different platforms or at different design levels. The purpose of the PSS tool 310 is to shorten the test time, and then make the test cases and verification plans achieve continuity in vertical reuse and cross-platform reuse. The PSS tool 310 generally uses DSL (Domain Specific Language) language to process internal logic.

The test environment 320 can be used to obtain a plurality of test cases 314 from the PSS tool 310. The test environment 320 can include a verification environment such as a Universal Verification Methodology (UVM) environment written in SystemVerilog language. In some embodiments, the test environment 320 can include a hardware emulation platform having a hardware emulator and a host, etc., to verify the DUT 230. In some other embodiments, the test environment 320 can include a software simulator to perform software simulation and test of the DUT 230.

FIG. 3B illustrates a schematic diagram of a PSS tool 310 according to embodiments of the present disclosure. As shown in FIG. 3B, the PSS tool 310 can further generate a scenario model 312, a plurality of test cases 314, and coverage comparison results 316. The user input 202 can include a configuration file 202a and a coverage target 202b. Generally, the PSS tool 310 can be a computer program running on the host 100 as shown in FIG. 1.

The configuration file 202a can include a description of the functionality of the DUT 230. The function of the DUT 230 can be a functional unit (e.g., a communication unit, a storage unit, or a computing unit) of the DUT 230. The functional unit can also be a small functional module within a large functional module (e.g., a general computing module, a neural network computing module, and the like in a computing module), or a part of a functional module (e.g., each address segment of a storage module, etc.). In short, the granularity of the description of the functionality of the DUT 230 can be specifically set according to the test requirements.

The coverage target 202b can include functional units of the DUT 230 that need to be covered during the test. In some embodiments, the coverage target 202b can be generated by the PSS tool 310 by default according to the configuration file 202a. In some other embodiments, the coverage target 202b can be described by the user in SystemVerilog language. The PSS tool 310 can convert the coverage target 202b described in SystemVerilog language into the coverage target described in DSL language, which can be parsed and processed by the PSS tool 310.

FIG. 3C illustrates a schematic diagram of exemplary code for a coverage test file 302 according to embodiments of the present disclosure. In some embodiments, the PSS tool 310 can generate coverage test file 302 based on the coverage target 202b. As shown in FIG. 3C, the coverage test file 302 can include the content of the coverage test, for example, the address “addr_c” and 13 coverage bins “bins b1” to “bins b13”.

The PSS tool 310 can generate the scenario model 312 from the configuration file 202a. In some embodiments, the scenario model generated from the configuration file 202a can be referred to as an initial scenario model.

The essence of a scenario model is the combination of action elements, auxiliary resources and logical control. It is appreciated that a scenario model can include a combination of valid action elements arranged in a certain execution sequence. Due to the declarative language nature of the Portable Stimulus Standard (PSS), the action element is an essential element of the Portable Stimulus Standard. For example, an action element can be a read operation, a write operation, or an operation of relocating data. The auxiliary resources include some auxiliary definitions such as struct, lock, share, pool, etc.

The scenario model 312 can include scenario descriptions and constraints. The scenario descriptions are used to define test scenarios. For example, for a bus, a test scenario can be defined as read, write, test (a test of random read and write 1000 times) and the like. Constraints can limit the test contents (e.g., an access mode, a number of packets, a size of data transferred at a time, an accessed address range, etc.) according to given conditions.

FIG. 3D illustrates a schematic diagram of exemplary code for a scenario model 312 according to embodiments of the present disclosure.

As shown in FIG. 3D, constraints and scenario descriptions are provided in a test component “pss_top”. For example, in the scenario model 312, one constraint is that the value of the initial address “start_addr” is restricted according to the type of field “transfer_s”. As another example, in the scenario model 312, a scenario description “read” is provided, in which the type of action, the address to be accessed, the data to be sent, and the like are defined.

FIG. 3E illustrates a schematic diagram of exemplary code for a test case 314 according to embodiments of the present disclosure.

The PSS tool 310 can further generate a plurality of test cases 314 according to the scenario model 312. The test cases can describe the contents to be tested and the functional units covered by the test cases. For example, a test case can describe the functionality of a storage unit which is tested by the test case. For example, referring to the above example, the PSS tool 310 can generate the plurality of test cases 314 that satisfy the scenario model 312 in the specific scenario according to the parameters and constraints provided in the scenario description “read”. The test cases 314 can include address information “addr_array” that is required to be tested by the coverage target 202b. As shown in FIG. 3E, the address information “addr_array” is specific and definite, for the comparison with coverage bins of the coverage test file 302.

The PSS tool 310 can further determine whether the plurality of test cases 314 satisfy the coverage target 202b. In some embodiments, the PSS tool 310 can determine the covered functional units based on the plurality of test cases. The PSS tool 310 can generate comparison results 316 by comparing the functional units covered by the plurality of test cases 314 with the functional units required to be covered in the coverage target 202b. The comparison results 316 can include whether the plurality of test cases 314 satisfy the coverage target 202b and functional units that are not covered yet. For example, the coverage target 202b can be verification of the four CPU cores in all read and write operations. Therefore, determining whether the plurality of test cases 314 satisfy the coverage target 202b can be understood as determining whether all the read and write tests are performed on the memory addresses (such as 0 to FFFF) of the core of each CPU according to the descriptions of the plurality of test cases 314. It can be determined that the plurality of test cases 314 satisfy the coverage target 202b if the descriptions include reads and writes for each address of each CPU.

In response to the plurality of test cases 314 failing to satisfy the coverage target 202b, the PSS tool 310 can determine a difference between the plurality of test cases 314 and the coverage target 202b based on the comparison results 316. The difference can include, for example, functional units that are not currently covered by the plurality of test cases.

The PSS tool 310 can update the scenario model 312 based on the difference. For example, the coverage target 202b can testing the memory addresses of b1 to b4, where b1, b2, b3, and b4 each represents a segment of addresses, then the constraint of the scenario model 312 can be the description of testing the memory addresses of b1 to b4, and the scenario description of the scenario model 312 can be testing the memory addresses by reading or writing. Further, the scenario description of the scenario model 312 can be testing the memory addresses by continuously reading or discretely writing. Assuming two test cases are generated according to the scenario model 312, they are reading the memory address of b1 and writing the memory address of b2, respectively. For example, by comparing the difference between each of the above two test cases and the coverage target, it is determined that the difference is testing the memory addresses of b3 to b4. After updating the scenario model 312 based on the difference, the constraint of the scenario model 312 can be changed to include the description of testing the memory addresses of b3 to b4.

In this way, the PSS tool 310 can generate a plurality of new test cases based on the updated scenario model. Through this looping manner, the plurality of test cases 314 generated based on the updated scenario model 312 can finally satisfy the coverage target 202b. The final test cases 314 can be output to the test environment 320 for verification.

In some embodiments, the operation of the PSS tool 310 can be static. That is, the operation of the PSS tool 310 does not enter into the simulation. The PSS tool 310 statically generates the plurality of test cases 314 according to the scenario model 312, and the plurality of test cases 314 can be descriptions of the stimulus required in the current test environment. The PSS tool 310 determines the difference between the plurality of test cases 314 and the coverage target 202b through these static descriptions.

As shown in FIG. 3C, according to the coverage test file 302, the PSS tool 310 can obtain the content of the coverage test. For example, the content of the coverage test can be testing the address “addr_c”, and the coverage bins of the address “addr_c” can include bins b1 to b13. As shown in FIG. 3E, the PSS tool 310 can obtain the address information “addr_array” from the generated test cases 314. The PSS tool 310 can compare the specific address information in “addr_array” with the addresses in bins b1 to b13 to obtain a comparison result 316. For example, the PSS tool 310 can compare the address “48571” with the addresses in bins b1 to b13 to determine which bin the address “48571” is located in or the address “48571” is not located in any bins. In this manner, the process continues until all the address information in the test cases 314 is compared. For example, if the address information “addr_array” in the test cases 314 can cover each of bins b1 to b13, the coverage of the test cases 314 is 100% and the coverage target 202b is satisfied.

In response to the plurality of test cases 314 failing to satisfy the coverage target 202b (e.g., the address information “addr_array” of the test cases 314 lacking addresses of bins b11), the PSS tool 310 can determine that the difference is lacking addresses of bins b11. After updating the scenario model 312 based on the difference (e.g., lacking addresses of bins b11), the PSS tool 310 can generate a plurality of new specific test cases according to the updated scenario model.

In this way, because the coverage test file 302 and the test cases 314 are specific and static, the PSS tool 310 can compare the coverage test file 302 with the test cases 314 to determine whether the test cases 314 satisfy the coverage test file 302 (i.e., the coverage target 202b) before running the simulation.

In some embodiments, because the test cases 314 generated by the PSS tool 310 are not dynamically generated in the test environment 320, the PSS tool 310 can save the test cases 314 and output the test cases 314 to other test environments for simulating the DUT 230 without regenerating test cases. This improves the reusability of the test cases 314, and also solves the problem of test cases being generated repeatedly for the DUT in different test environments.

In the embodiments of the present disclosure, the PSS tool 310 acquires the configuration file 202a and the coverage target 202b of the logical system design, generates the default scenario model 312 according to the configuration file 202a, and then generates the plurality of test cases 314. Before running the simulation, the PSS tool 310 can statically determine whether the plurality of test cases 314 satisfy the coverage target 202b. If the plurality of test cases 314 fail to satisfy the coverage target 202b, then the difference between the plurality of test cases 314 and the coverage target 202b are used to modify the scenario model 312. If the plurality of test cases 314 satisfy the coverage target 202b, then the plurality of test cases 314 are output to the test environment 320. At the same time, the PSS tool 310 can save the plurality of test cases 314 and output them to other test environments for testing the DUT, which improves the reusability of the test cases and solves the problem of test cases being generated repeatedly for the DUT in different test environments.

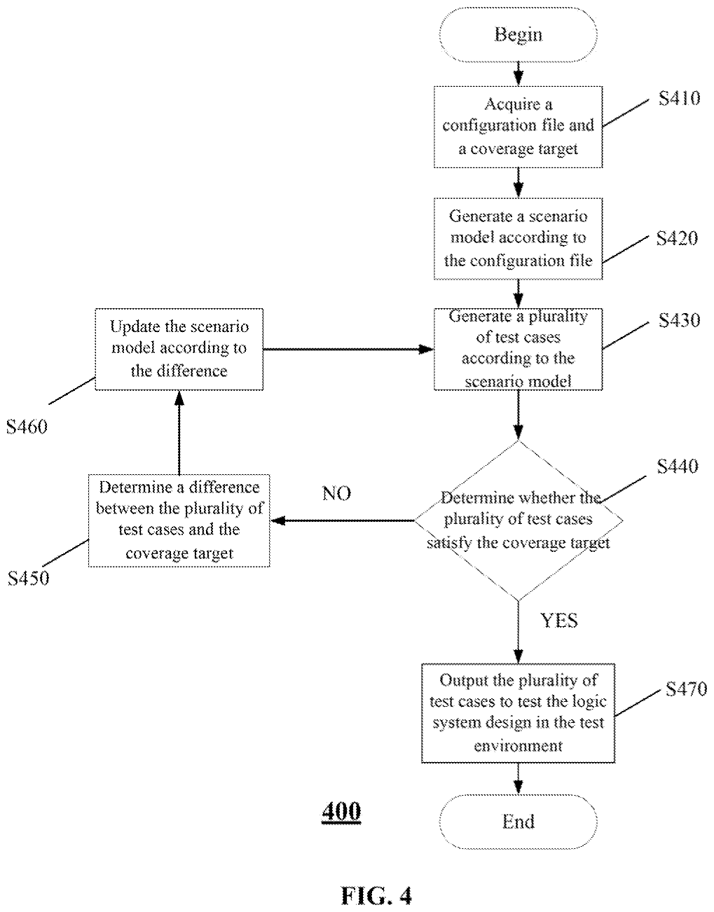

FIG. 4 is a flowchart of a method 400 for generating test cases according to embodiments of the present disclosure. Test cases are used to test a plurality of functional units of the logical system design during the simulation/emulation process of the logical system design. The method can be implemented by the PSS tool 310 as shown in FIG. 3A, which can be executed on the host 100. As shown in FIG. 4, the method 400 can include the following steps.

In step S410, the PSS tool 310 can acquire a configuration file (e.g., the configuration file 202a as shown in FIG. 3B) and a coverage target (e.g., the coverage target 202b as shown in FIG. 3B). It is appreciated that the configuration file can include descriptions of a plurality of functions of the logical system design. The coverage target can include test contents corresponding to the plurality of functions. In some embodiments, the coverage target can be a default coverage target generated by the PSS tool 310 based on the configuration file. In some other embodiments, the coverage target can be a user-defined coverage target. For example, the coverage target 202b is a test coverage target described in SystemVerilog language. In some embodiments, the PSS tool 310 can convert the user-defined coverage target into the coverage target in a PSS environment.

In some embodiments, the PSS tool 310 can generate a coverage test file (e.g., the coverage test file 302 as shown in FIG. 3C) according to the coverage target. The coverage test file can include the contents of the coverage test (e.g., the address “addr_c” as shown in FIG. 3C) and a plurality of coverage bins (e.g., “bins b1” to “bins b13” as shown in FIG. 3C).

In step S420, the PSS tool 310 can generate a scenario model (e.g., the scenario model 312 as shown in FIG. 3B or FIG. 3D) according to the configuration file.

In step S430, the PSS tool 310 can generate a plurality of test cases (e.g., the plurality of test cases 314 as shown in FIG. 3B or FIG. 3D) according to the scenario model.

In step S440, the PSS tool 310 can determine whether the plurality of test cases satisfy the coverage target (e.g., the coverage target 202b as shown in FIG. 3B). In some embodiments, the PSS tool 310 can obtain test content descriptions of the plurality of test cases (e.g., address information “addr_array” as shown in FIG. 3E) from the plurality of test cases, compare the test content descriptions with the coverage test file (e.g., the coverage test file 302 as shown in FIG. 3C), and then statically determine whether the plurality of test cases satisfy the coverage target according to the comparison result. In some embodiments, the PSS tool 310 can compare the test content descriptions with each coverage bin in the coverage test file (e.g., “bins b1” to “bins b13” as shown in FIG. 3C).

In step S450, in response to the plurality of test cases failing to satisfy the coverage target, the PSS tool 310 can determine a difference between the plurality of test cases and the coverage target. For example, the coverage target can be continuously testing the memory addresses of b1˜b4, wherein b1, b2, b3, and b4 each represents a segment of addresses, and the plurality of test cases can be continuous reading of the memory address of b1 and discrete writing of the memory address of b2. The PSS tool 310 can compare each of the two test cases with the coverage target, and determine that the first test case (i.e., the continuous reading of the memory address of b1) satisfies part of the coverage target, and thus b1 has been tested. However, because the second test case is a discrete test, it is not related to the coverage target. Therefore, the difference can be the continuous testing of the memory addresses of b2˜b4.

In step S460, the PSS tool 310 can update the scenario model according to the difference. In some embodiments, the PSS tool 310 can determine, from the text contents, difference test contents associated with the difference; and modify the scenario model according to the difference test contents. For example, the constraints of the scenario model can be continuous testing of the memory addresses of b1˜b4, the scenario description of the scenario model can be read or write, and the difference can be the continuous testing of the memory addresses of b2˜b4. Therefore, the PSS tool 310 can update the constraints of the scenario model according to the difference test content, for example, to include continuously testing of the memory addresses of b2˜b4.

In step S470, in response to the plurality of test cases satisfying the preset coverage target, the PSS tool 310 can output the plurality of test cases to test the logic system design in the test environment. For example, as shown in FIG. 3A, the test cases can be applied to the DUT 230 via the test environment 320. It should be noted that the PSS tool 310 can save the test cases. The saved test cases can be applied to the DUT 230 via other test environments without regenerating the test cases.

Embodiments of the present disclosure can statically determine a difference between a plurality of test cases and the coverage target, and then generate a plurality of new test cases according to the difference, so that the plurality of test cases can converge to the coverage target fast before running the simulation, and improve the effectiveness and accuracy of the simulation test. At the same time, the test cases generated by a PSS tool can be saved and transmitted to different test environments, which improves the reusability of the test cases and solves the problem of test cases being generated repeatedly for the DUT in different test environments.

It should be noted that the method of the present disclosure can be executed by a single device, such as a computer or a server. The method in these embodiments can also be applied in a distributed scenario, and is completed by the cooperation of a plurality of devices. In the case of such a distributed scenario, one device among the plurality of devices can only execute one or more steps in the method of the present disclosure, and the plurality of devices will interact with each other to complete the described method.

Embodiments of the present disclosure further provide a storage medium, where the storage medium stores at least one set of instructions, and when the instructions are executed, the method for generating a test case provided by the embodiments of the present disclosure is executed.

Embodiments of the present disclosure also provide a computer-readable storage medium storing instructions. The instructions, when executed by the apparatus, are used to perform the above-described method. The computer-readable storage media, including persistent and non-permanent, removable and non-removable media, can be implemented by any method or technology for information storage. Information can be computer readable instructions, data structures, modules of programs, or other data. Examples of computer storage media include, but are not limited to, phase-change memory (PRAM), static random access memory (SRAM), dynamic random access memory (DRAM), other types of random access memory (RAM), read only memory (ROM), Electrically Erasable Programmable Read Only Memory (EEPROM), Flash Memory or other memory technology, Compact Disc Read Only Memory (CD-ROM), Digital Versatile Disc (DVD) or other optical storage, Magnetic tape cassettes, magnetic tape magnetic disk storage or other magnetic storage devices or any other non-transmission medium that can be used to store information that can be accessed by a computing device.

Those skilled in the art can easily derive other embodiments of the present application after considering and practicing the above disclosure. The present disclosure is aimed at covering any variations, use or adaptive changes of the present disclosure, and the variations, use or adaptive changes conform to the general principle of the present disclosure and include common knowledge or common technical means in the technical field not disclosed in the present disclosure. The specification and embodiments are merely regarded as exemplary, and the scope and spirit of the present disclosure are defined by the accompanied claims.

It should be understood that the present disclosure is not limited to the accurate structure described above and illustrated in the drawings, and various modifications and changes can be made without departing from the scope thereof. The scope of the invention is only limited by the appended claims.

What is claimed is:

1. A method for generating a plurality of test cases by a Portable Stimulus Standard (PSS) tool in a PSS environment, wherein the test cases are used to test a logic system design, the method comprising:
acquiring a configuration file and a coverage target of the logic system design;
generating a scenario model according to the configuration file;
generating the plurality of test cases according to the scenario model;
determining whether the plurality of test cases satisfy the coverage target;
in response to the plurality of test cases failing to satisfy the coverage target, determining a difference between the plurality of test cases and the coverage target; and
updating the scenario model according to the difference.

2. The method of claim 1, further comprising:
generating a coverage test file according to the coverage target, wherein the coverage test file includes contents of the coverage test and a plurality of coverage bins.

3. The method of claim 2, wherein determining whether the plurality of test cases satisfy the coverage target further comprises:
acquiring test content descriptions of the plurality of test cases based on the plurality of test cases;
comparing the test content descriptions with the coverage test file to obtain a comparison result; and
statically determining whether the plurality of test cases satisfy the coverage target according to the comparison result.

4. The method of claim 3, wherein comparing the test content descriptions with the coverage test file further comprises:
comparing the test content descriptions with each of the coverage bins.

5. The method of claim 1, further comprising:
in response to the plurality of test cases satisfying a predetermined condition, outputting the plurality of test cases to test the logic system design in a test environment.

6. The method of claim 1, wherein the coverage target includes a user-defined coverage target or a default coverage target generated based on the configuration file.

7. The method of claim 6, further comprising:
receiving the user-defined coverage target, wherein the user-defined coverage target is described in SystemVerilog language; and
converting the user-defined coverage target into the coverage target, wherein the coverage target is the coverage target in the PSS environment.

8. The method of claim 1, wherein the configuration file includes descriptions of a plurality of functions of the logic system design, and the coverage target includes test contents corresponding to the plurality of functions.

9. The method of claim 8, wherein:
the scenario model further includes scenario descriptions and constraints; and
updating the scenario model according to the difference further comprises:
determining, from the text contents, difference test contents associated with the difference; and
modifying the scenario model according to the difference test contents, including updating the constraints according to the difference test contents.

10. An apparatus for generating a plurality of test cases by a Portable Stimulus Standard (PSS) tool in a PSS environment, wherein the test cases are used to test a logic system design, the apparatus comprising:
a memory storing a set of instructions; and
at least one processor, configured to execute the set of instructions to:
acquire a configuration file and a coverage target of the logic system design;
generate a scenario model according to the configuration file;
generate the plurality of test cases according to the scenario model;
determine whether the plurality of test cases satisfy the coverage target;
in response to the plurality of test cases failing to satisfy the coverage target, determine a difference between the plurality of test cases and the coverage target; and
update the scenario model according to the difference.

11. The apparatus of claim 10, wherein the at least one processor is further configured to execute the set of instructions to:
generate a coverage test file according to the coverage target, wherein the coverage test file includes contents of the coverage test and a plurality of coverage bins.

12. The apparatus of claim 11, wherein the at least one processor is further configured to execute the set of instructions to:
acquire test content descriptions of the plurality of test cases based on the plurality of test cases;
compare the test content descriptions with the coverage test file to obtain a comparison result; and
statically determine whether the plurality of test cases satisfy the coverage target according to the comparison result.

13. The apparatus of claim 12, wherein the at least one processor is further configured to execute the set of instructions to:
compare the test content descriptions with each of the coverage bins.

14. The apparatus of claim 10, wherein the at least one processor is further configured to execute the set of instructions to:
in response to the plurality of test cases satisfying a predetermined condition, output the plurality of test cases to test the logic system design in a test environment.

15. The apparatus of claim 10, wherein the coverage target includes a user-defined coverage target or a default coverage target generated based on the configuration file.

16. The apparatus of claim 15, wherein the at least one processor is further configured to execute the set of instructions to:
receive the user-defined coverage target, wherein the user-defined coverage target is described in System Verilog language; and
convert the user-defined coverage target into the coverage target, wherein the coverage target is the coverage target in the PSS environment.

17. The apparatus of claim 10, wherein the configuration file includes descriptions of a plurality of functions of the logic system design, and the coverage target includes test contents corresponding to the plurality of functions.

18. The apparatus of claim 17, wherein:
the scenario model further includes scenario descriptions and constraints; and
the at least one processor is further configured to execute the set of instructions to:
determine, from the test contents, difference test contents associated with the difference; and
modify the scenario model according to the difference test contents, including updating the constraints according to the difference test contents.

19. A non-transitory computer-readable storage medium storing a set of instructions that, when executed by a processor, causes the processor to perform a method for generating a plurality of test cases by a Portable Stimulus Standard (PSS) tool in a PSS environment, wherein the test cases are used to test a logic system design, the method comprising:
acquiring a configuration file and a coverage target of the logic system design;
generating a scenario model according to the configuration file;
generating the plurality of test cases according to the scenario model;
determining whether the plurality of test cases satisfy the coverage target;
in response to the plurality of test cases failing to satisfy the coverage target, determining a difference between the plurality of test cases and the coverage target; and
updating the scenario model according to the difference.
